(19) United States
(12) Patent Application Publication
(10) Pub. No.: US 2013/0188370 A1
(43) Pub. Date: Jul. 25, 2013

(54) Lamp Housing Capable of Serving as Bobbin for an LED Lamp

(71) Applicant: Rene Frederik Koch, New Taipei City (TW)

(72) Inventor: Rene Frederik Koch, New Taipei City (TW)

(21) Appl. No.: 13/364,372

(22) Filed: Feb. 2, 2012

(30) Foreign Application Priority Data
Jan. 20, 2012 (TW) 101102558

(51) Int. Cl. F21V 15/00

(52) U.S. Cl. 362/364

(57) ABSTRACT

A lamp housing capable of serving as a bobbin for a light emitting diode (LED) lamp has a containing portion for receiving a converter module, and a winding portion for mounting a cap. Windings of inductor unit of the converter module are wound on the winding portion and form large inductance that is able to replace multiple inductors and a surge protector that are originally mounted on a circuit board of the converter module. The LED lamp with the lamp housing has reduced emissions and enhanced effect of protecting against electrical surge and spikes, and meets safety regulations. Since electrical elements mounted on the circuit board are reduced and the metal cap also dissipates heat generated by the windings of the inductor unit, the converter module operates properly under suitable temperatures.

### BACKGROUND OF THE INVENTION

1. Field of the Invention

The present invention relates to a lamp housing for a light emitting diode (LED) lamp, especially to a lamp housing that is also capable of serving as a bobbin.

2. Description of the Prior Art(s)

Light emitting diode (LED) lamps that are intended to be interchangeable with incandescent lamps are made in standard light bulb shapes. With reference to FIG. 4, a conventional base 40 of an LED lamp has a housing 41, a cap 42 and a converter module 43. The housing 41 has a containing portion 411, a containing recess 412 and a cap mount 413. The containing recess 412 is formed in a top of the containing portion 411. The cap mount 413 protrudes from a bottom of the containing portion 411. The cap 42 is metal and is securely mounted on and around the cap mount 413 of the housing 41.

With further reference to FIG. 5, the converter module 43 is mounted in the containing recess 412 of the housing 41 and has a circuit board 431 with a transformer unit 432 and multiple capacitors 433 mounted thereon. Thus, alternating current (AC) provided by a domestic power supply is converted to direct current (DC) through the converter module 43 and provides electric power to an LED module of the LED lamp.

To meet safety regulations and be certified by certification organization, emissions that are unnecessary for operation have to be reduced, minimized or eliminated, and effect of protecting against electrical surge and spikes, including those caused by lightning, has to be enhanced. Therefore, two to three inductors 434 and a surge protector 435 need to be mounted on the circuit board 431 of the converter module 43.

However, the inductors 434 and the surge protector 435 not only generate heat but also occupy space in the containing recess 412 of the housing 41. Since the heat in the housing 41 is hard to be dissipated, temperature in the housing 41 is raised. Magnetic components, such as the transformer unit 432, the capacitor 433, the inductors 434 and the surge protector 435 easily fail under high temperature, leaving the conventional LED lamp unprotected.

To overcome the shortcomings, the present invention provides a lamp housing capable of serving as a bobbin for an LED lamp to mitigate or obviate the aforementioned problems.

### SUMMARY OF THE INVENTION

The main objective of the present invention is to provide a lamp housing capable of serving as a bobbin for a light emitting diode (LED) lamp. The lamp housing has a containing portion for receiving a converter module, and a winding portion. The winding portion is formed on and protrudes from a bottom of the containing portion and is used for mounting a cap.

Windings of inductor unit of the converter module are wound on the winding portion of the lamp housing and form large inductance that is able to replace multiple inductors and a surge protector that are originally mounted on a circuit board of the converter module. Therefore, the LED lamp with the lamp housing has reduced emissions and enhanced effect of protecting against electrical surge and spikes, and meets safety regulations. Furthermore, since electrical elements mounted on the circuit board are reduced and the metal cap also dissipates heat generated by the windings of the inductor unit, the converter module operates properly under suitable temperatures.

Other objectives, advantages and novel features of the invention will become more apparent from the following detailed description when taken in conjunction with the accompanying drawings.

### BRIEF DESCRIPTION OF THE DRAWINGS

FIG. 1 is an operational exploded perspective view of a lamp housing capable of serving as a bobbin for a light emitting diode (LED) lamp in accordance with the present invention;

FIG. 2 is an operational side view in partial section of the lamp housing in FIG. 1;

FIG. 3 is an operational side view in partial section of another embodiment of a lamp housing capable of serving as a bobbin for an LED lamp in accordance with the present invention;

FIG. 4 is an operational side view in partial section of a conventional lamp housing for an LED lamp in accordance with the prior art; and

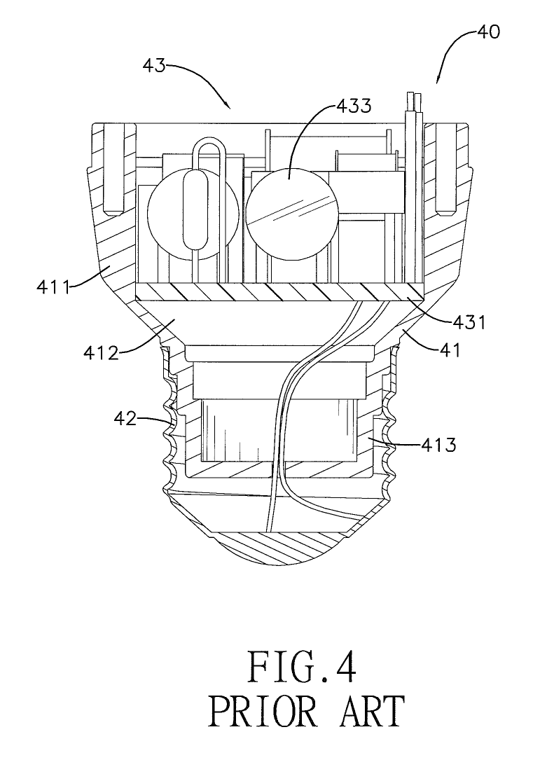

FIG. 5 is an operational top view of the conventional lamp housing in FIG. 4.

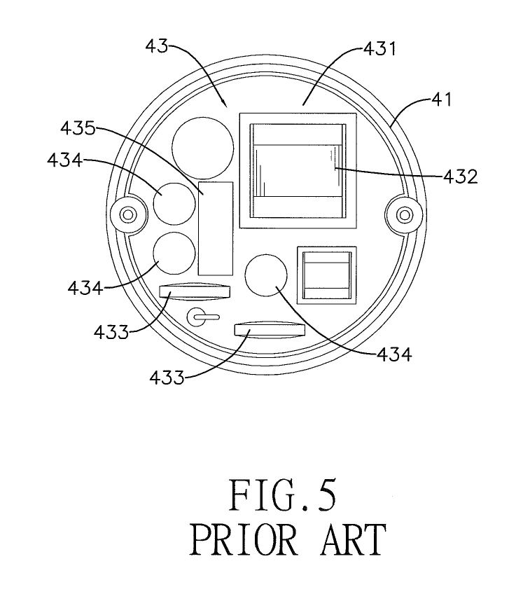

### DETAILED DESCRIPTION OF THE PREFERRED EMBODIMENTS

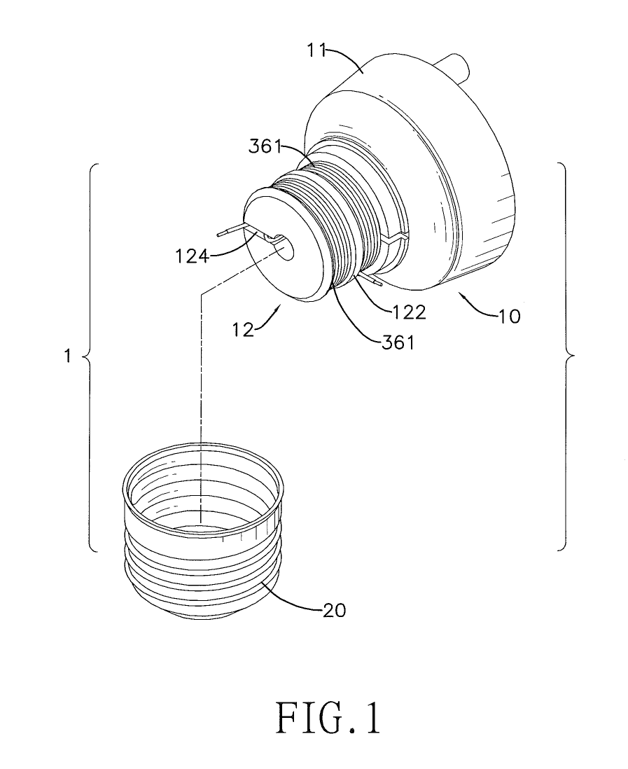

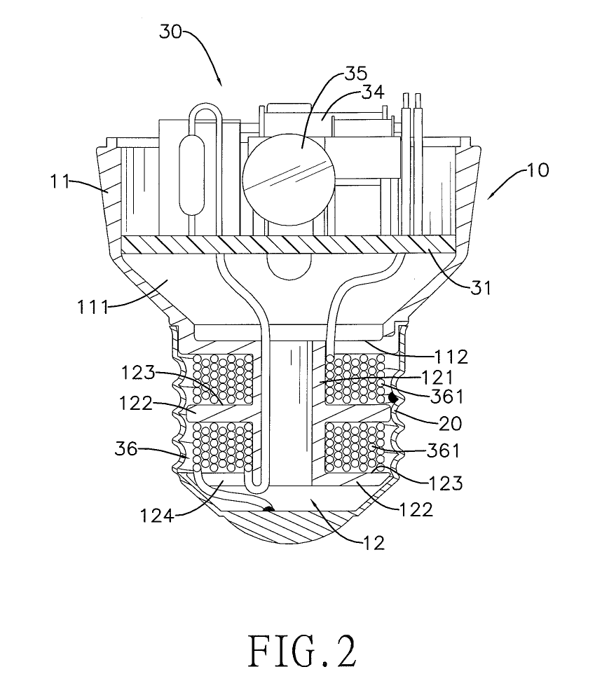

With reference to FIGS. 1 and 2, a base 1 of a light emitting diode (LED) lamp has a lamp housing 10 in accordance with the present invention, a cap 20 and a converter module 30.

The lamp housing 10 is capable of serving as a bobbin for the LED lamp and comprises a containing portion 11 and a winding portion 12. The containing portion 11 has a containing recess 111 and a slot 112. The containing recess 111 is formed in a top of the containing portion 11. The slot 112 of the containing portion 11 is formed through a bottom of the containing portion 11. The winding portion 12 is formed on the bottom of the containing portion 11 and has a core tube 121, at least one partition panel 122 and at least one winding recess 123. The core tube 121 protrudes from the bottom of the containing portion 11. The at least one partition panel 122 is formed around an outer surface of the core tube 121. The at least one winding recess 123 is defined between the bottom of the containing portion 11 and the at least one partition panel 122.

In the preferred embodiment, the winding portion 12 has two partition panels 122 and two winding recesses 123. The partition panels 122 are separately formed around the outer surface of the core tube 121. The winding recesses 123 are respectively defined between the partition panels 122 and between the bottom of the containing portion 11 and the partition panel 122 that is disposed beside the bottom of the containing portion 11. The partition panel 122 that is disposed adjacent to a distal end of the core tube 121 has a slot 124 formed through the partition panel 122.

The cap 20 is mounted on and around the winding portion 12 of the lamp housing 10. In the preferred embodiment, the cap 20 is an Edison screw cap, such as E26, E27 and the like, is metal and has an outer surface being threaded.

The converter module 30 has a circuit board 31, a transformer unit 34, multiple capacitors 35 and an inductor unit 36. The circuit board 31 is mounted in the containing recess 111 of the lamp housing 10. The transformer unit 34 and the capacitors 35 are mounted on the circuit board 31. The inductor unit 36 has two windings 361 respectively wound around the core tube 121 of the winding portion 12 of the lamp housing 10 in the winding recesses 123 of the winding portion 12.

Preferably, the core tube 121 of the winding portion 12 of the lamp housing 10 may be hollow and communicate with the containing recess 111 of the containing portion 11. Thus, the inductor unit 36 becomes an air core inductor.

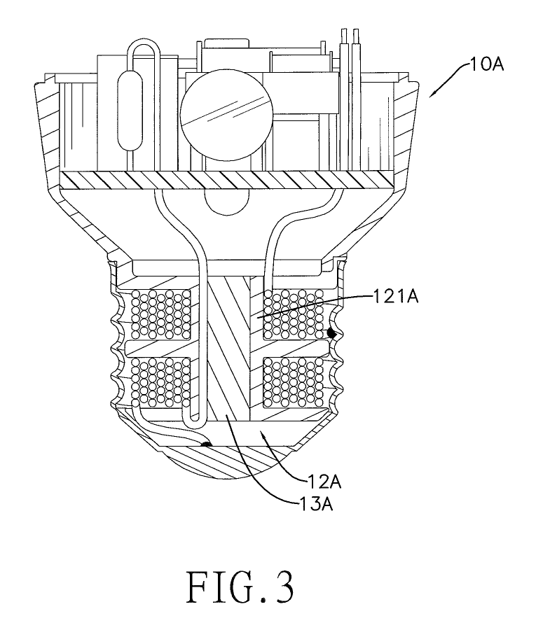

With reference to FIG. 3, preferably, a ferromagnetic material 13A may be embedded in the core tube 121A of the winding portion 12A of the lamp 10A. Thus, with different ferromagnetic materials 13A embedded in the core tube 121A, the inductor unit 36 forms different inductance.

The lamp housing 10, 10A as described has the following advantages. The windings 361 that are wound on the winding portion 12, 12A of the lamp housing 10, 10A form large inductance that is able to replace two to three inductors and a surge protector. Therefore, the LED lamp with the lamp housing 10, 10A has reduced emissions and enhanced effect of protecting against electrical surge and spikes, and meets safety regulations. Furthermore, electrical elements mounted on the circuit board 31 are reduced so less heat is generated and accumulated in the containing recess 111 of the lamp housing 10, 10A. Moreover, the metal cap 20 that is mounted around the winding portion 12, 12A dissipates heat generated by the windings 361 of the inductor unit 36. Consequently, the converter module 30 operates properly under suitable temperatures.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lamp housing for a light emitting diode (LED) lamp comprising
a containing portion having a containing recess formed in a top of the containing portion; and
a winding portion formed on a bottom of the containing portion and having
a core tube protruding from the bottom of the containing portion;
at least one partition panel formed around an outer surface of the core tube; and
at least one winding recess defined between the bottom of the containing portion and the at least one partition panel.

2. The lamp housing as claimed in claim 1, wherein the winding portion has
two partition panels separately formed around the outer surface of the core tube; and
two winding recesses respectively defined between the partition panels and between the bottom of the containing portion and the partition panel that is disposed beside the bottom of the containing portion.

3. The lamp housing as claimed in claim 1, wherein the core tube of the winding portion is hollow.

4. The lamp housing as claimed in claim 2, wherein the core tube of the winding portion is hollow.

5. The lamp housing as claimed in claim 1, wherein a ferromagnetic material is embedded in the core tube of the winding portion.

6. The lamp housing as claimed in claim 2, wherein a ferromagnetic material is embedded in the core tube of the winding portion.

7. The lamp housing as claimed in claim 1, wherein
the containing portion further has a slot formed through the bottom of the containing portion; and
the partition panel that is disposed adjacent to a distal end of the core tube has a slot formed through the partition panel.

8. The lamp housing as claimed in claim 2, wherein
the containing portion further has a slot formed through the bottom of the containing portion; and
the partition panel that is disposed adjacent to a distal end of the core tube has a slot formed through the partition panel.

9. The lamp housing as claimed in claim 3, wherein
the containing portion further has a slot formed through the bottom of the containing portion; and
the partition panel that is disposed adjacent to a distal end of the core tube has a slot formed through the partition panel.

10. The lamp housing as claimed in claim 4, wherein
the containing portion further has a slot formed through the bottom of the containing portion; and
the partition panel that is disposed adjacent to a distal end of the core tube has a slot formed through the partition panel.

11. The lamp housing as claimed in claim 5, wherein
the containing portion further has a slot formed through the bottom of the containing portion; and
the partition panel that is disposed adjacent to a distal end of the core tube has a slot formed through the partition panel.

12. The lamp housing as claimed in claim 6, wherein
the containing portion further has a slot formed through the bottom of the containing portion; and
the partition panel that is disposed adjacent to a distal end of the core tube has a slot formed through the partition panel.
